(19) United States
(12) Patent Application Publication
(10) Pub. No.: US 2010/0252357 A1
(43) Pub. Date: Oct. 7, 2010

(54) SOUND INSULATION STRUCTURE OF INTERNAL COMBUSTION ENGINE

(76) Inventors: Kashirou Fukami, Aichi-ken (JP); Kouji Kawaguchi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/159,144

(22) PCT Filed: Dec. 26, 2006
(86) PCT No.: PCT/JP2006/326356

§ 371 Date: Jun. 25, 2008

(30) Foreign Application Priority Data
Dec. 28, 2005 (JP) 2005-379119

(51) Int. Cl. F02B 77/13

(52) U.S. Cl. 181/204

(57) ABSTRACT

Provided is a sound insulation structure of an internal combustion engine capable of preventing propagation of a sound generated by an injector into an interior of a vehicle. The sound insulation structure of the internal combustion engine includes a V-type cylinder block having a right bank and a left bank; a right bank intake pipe supplying a gas to the right bank; a left bank intake pipe supplying the gas to the left bank and intersecting the right bank intake pipe; in-cylinder injection injectors arranged in a surrounded space surrounded by the right and left banks and the intake pipes; and a sound insulation member arranged in the surrounded space between the in-cylinder injection injectors and an intersection region.

### TECHNICAL FIELD

The invention relates to a sound insulation structure of an internal combustion engine, and particularly to a sound insulation structure of an internal combustion engine for shutting off sounds generated by a fuel injection device.

### BACKGROUND ART

A sound insulation structure of an internal combustion engine has been disclosed, e.g., in Japanese Patent Laying-Open No. 2000-179351 (Patent Reference 1).

### DISCLOSURE OF THE INVENTION

The patent reference 1 has disclosed a structure in which a sound insulation cover is arranged around a direct-injection fuel infection valve located outside an engine body.

In a V-type engine, a fuel injection device is arranged in a narrow region between right and left banks, and prior arts have suffered from a problem that a sound insulation cover cannot be arranged in such a narrow region without difficulty.

Accordingly, the invention has been made for overcoming the above problem, and an object of the invention is to provide a sound insulation structure of an internal combustion engine that can suppress propagation of a sound generated by an engine body into an interior of a vehicle.

A sound insulation structure of an internal combustion engine according to the invention includes a cylinder block having left and right banks; a plurality of first intake pipes supplying a gas to the right bank; a plurality of second intake pipes supplying the gas to the left bank and intersecting the first intake pipes; a fuel injection device arranged in a surrounded space surrounded by the right and left banks and the first and second intake pipes; and a sound insulation member arranged in the surrounded space between the fuel injection device and an intersection region containing intersecting portions of the first and second intake pipes, being in contact with both the first and second intake pipes and extending in a direction of alignment of the plurality of first and second intake pipes.

According to the sound insulation structure of the internal combustion engine having the above structure, the sound insulation member is arranged in a surrounded region surrounded by the right and left banks and the first and second intake pipes, and the sound insulation member is in contact with both the first and second intake pipes, and extends in the direction of alignment of the plurality of first and second intake pipes. Therefore, the sound insulation member can absorb a sound generated by a fuel supply device arranged in the surrounded space.

Preferably, the sound insulation member is arranged between the plurality of first and second intake pipes. This structure can prevent leakage of the sound through a space between the plurality of first and second intake pipes, and can achieve higher sound insulation performance.

More preferably, the sound insulation member is arranged integrally. Since no gap is present in the sound insulation member, this structure can increase the sound insulation performance.

Further preferably, a gap is formed between the intersection region and the sound insulation member. Since an air flows through this gap, this structure can lower a temperature of the sound insulation member adjoining the gap, and can lower a temperature of the surrounded space. Consequently, the temperature of the fuel injection device arranged in the surrounded space can be lowered to prevent vaporization of the fuel in the fuel injection device.

Preferably, the sound insulation structure of the internal combustion engine further includes a cylinder head arranged on the right and left banks, and a gasket arranged between the cylinder head and the first and second intake pipes, and the gasket is integral with the sound insulation member. This structure can suppress transmission of a heat from the cylinder head to the first and second intake pipes. Therefore, it is possible to suppress increase in temperature of the surrounded space, and therefore to suppress the vaporization of fuel in the fuel injection device arranged in the surrounded space.

More preferably, the sound insulation member is formed of urethane foam. Since the urethane foam has a good sound insulation property and is light and flexible, it can be worked or processed easily.

Preferably, the sound insulation member is arranged in contact with the fuel injection device. In this structure, the sound insulation member in contact with the fuel injection device can absorb more reliably the sound generated by the fuel injection device.

Preferably, the sound insulation member is engaged between the plurality of first and second intake pipes. The first and second intake pipes can be attached to another member such as a cylinder head while holding the engaged sound insulation member between the first and second intake pipes, and this structure can improves an assembly property.

The invention can provide the sound insulation structure of the internal combustion engine having an improved sound insulation performance.

### BRIEF DESCRIPTION OF THE DRAWINGS

FIG. 1 is a cross section of a sound insulation structure of an internal combustion engine according to a first embodiment of the invention.

FIG. 2 is a bottom view of the sound insulation member.

FIG. 3 is a side view of the sound insulation member viewed in a direction of an arrow III in FIG. 2.

FIG. 4 is a plan of the sound insulation member viewed in a direction of an arrow IV in FIG. 3.

FIG. 5 is a side view of the sound insulation member viewed in a direction of an arrow V in FIG. 4.

FIG. 6 is a plan of an intake manifold having the sound insulation member arranged therein.

FIG. 7 is a side view of the intake manifold having the sound insulation member arranged therein.

FIG. 8 is a bottom view of the intake manifold having the sound insulation member arranged therein.

FIG. 9 is a perspective view of the intake manifold and gaskets.

FIG. 10 is a cross section of a sound insulation structure of an internal combustion engine according to a second embodiment of the invention.

FIG. 11 is a cross section of a sound insulation structure of an internal combustion engine according to a third embodiment of the invention.

### BEST MODES FOR CARRYING OUT THE INVENTION

Embodiments of the invention will now be described with reference to the drawings. The same or corresponding portions in the following embodiments bear the same reference numbers, and description thereof is not repeated.

### First Embodiment

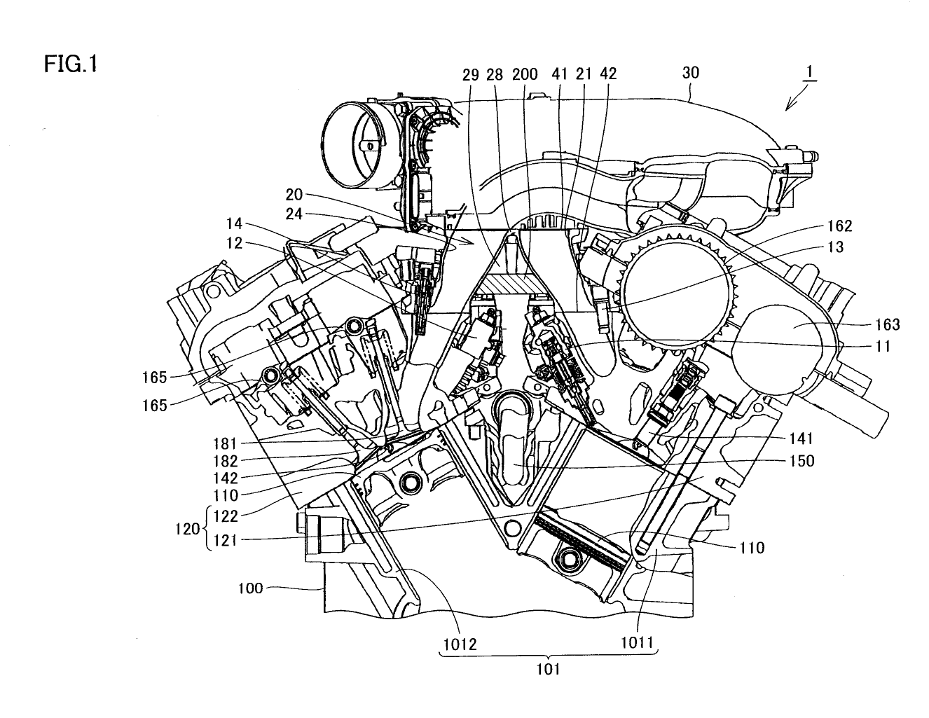

FIG. 1 is a cross section of a sound insulation structure of an internal combustion engine according to a first embodiment of the invention. Referring to FIG. 1, a sound insulation structure 1 of the internal combustion engine according to the first embodiment of the invention includes in-cylinder injection injectors 11 and 12 that are fuel injection devices and supply a fuel to an engine 100, i.e., the internal combustion engine, an intake manifold 20 that is an intake pipe structure made of metal and supplies a gas to engine 100, and a surge tank unit 30 that is an intake pipe structure made of plastic and is coupled to intake manifold 20.

Engine 100 has a cylinder block 101, in which a piston 110 is arranged. Piston 110 is connected to a crankshaft by a connecting rod.

Cylinder block 101 has right and left banks 1011 and 1012, which intersect together with a predetermined angle therebetween. The angle between right and left banks 1011 and 1012 is merely required to be larger than 0 degrees and smaller than 180 degrees. Although this embodiment relates to the V-type engine, this is not restrictive, and the invention may be applied to a W-type engine and others that have a right bank(s) forming an angle with respect to a left bank(s).

A right bank cylinder head 121 is arranged on right bank 1011, and a left bank cylinder head 122 is arranged on left bank 1012. Right and left bank cylinder heads 121 and 122 form a cylinder head 120. Spark plugs 141 and 142 are arranged in cylinder head 120. An intake valve 181 and an exhaust valve 182 are arranged on the opposite sides of the spark plug for controlling flow of an air-fuel mixture into a combustion chamber and discharge of an exhaust gas from the combustion chamber. Intake and exhaust valves 181 and 182 are driven by rocker arms 165, respectively.

A water bypass pipe 150 is arranged between right and left banks 1011 and 1012.

In-cylinder injection injector 11 is arranged in right bank cylinder head 121, and in-cylinder injection injector 12 is arranged in left bank cylinder head 122. In-cylinder injection injectors 11 and 12 are fuel injection devices for directly injecting the fuel into the combustion chambers, respectively. In-cylinder injection injectors 11 and 12 that are the in-cylinder fuel injection devices are arranged in a region surrounded by right and left banks 1011 and 1012.

Intake manifold 20 is arranged above right and left bank cylinder heads 121 and 122. Intake manifold 20 is made of metal, and port injection injectors 13 and 14 (i.e., injectors for port injection) inject the fuel into an air passed through intake manifold 20. Port injection injectors 13 and 14 are attached to right and left cylinder heads 121 and 122, respectively. An intake variable valve timing mechanism 162 and an exhaust variable valve timing mechanism 163 controls timing of opening/closing operations of intake and exhaust valves 181 and 182, respectively.

Intake manifold 20 has a right bank intake pipe 21 and a left bank intake pipe 24, which are shaped to gather in an intersection region 28. A contact surface of intake manifold 20 with respect to cylinder heads 121 and 122 of the right and left banks form a junction surface 42, and a contact surface of intake manifold 20 with respect to surge tank unit 30 forms a junction surface 41. A region surrounded by right and left bank intake pipes 21 and 24 of intake manifold 20 forms a surrounded space 29, in which a sound insulation member 200 made of urethane foam is arranged. In this embodiment, sound insulation member 200 is in contact with intake manifold 20. However, this structure is not restrictive, and sound insulation member 200 may be in contact with right and left bank cylinder heads 121 and 122.

Instead of or in addition to the urethane form, sound insulation member 200 may be made of e.g., unwoven fabric of metal. Also, it may be made of an organic material such as engineering plastic.

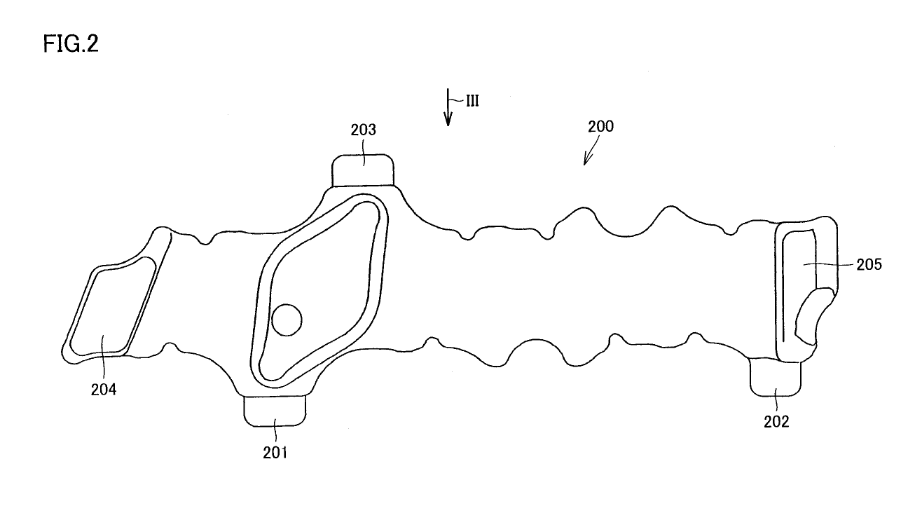

FIG. 2 is a bottom view of the sound insulation member. Referring to FIG. 2, sound insulation member 200 extends in a direction of arrangement of pistons. Sound insulation member 200 is provided at its longitudinally opposite ends with legs 204 and 205, which are located at opposite ends of the cylinder, respectively, and cover the surrounded space. Projections 201, 202 and 203 are arranged between two legs 204 and 205 for engagement with intake manifold 20.

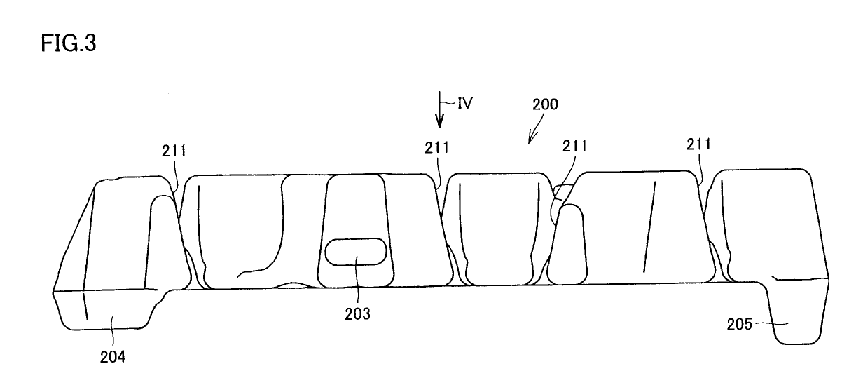

FIG. 3 is a side view of a sound insulation member viewed in a direction of an arrow III in FIG. 2. Referring to FIG. 3, legs 204 and 205 of sound insulation member 200 protrudes downward, and other portions of sound insulation member 200 have substantially flat lower surfaces. Projection 203 is located at a higher position than legs 204 and 205.

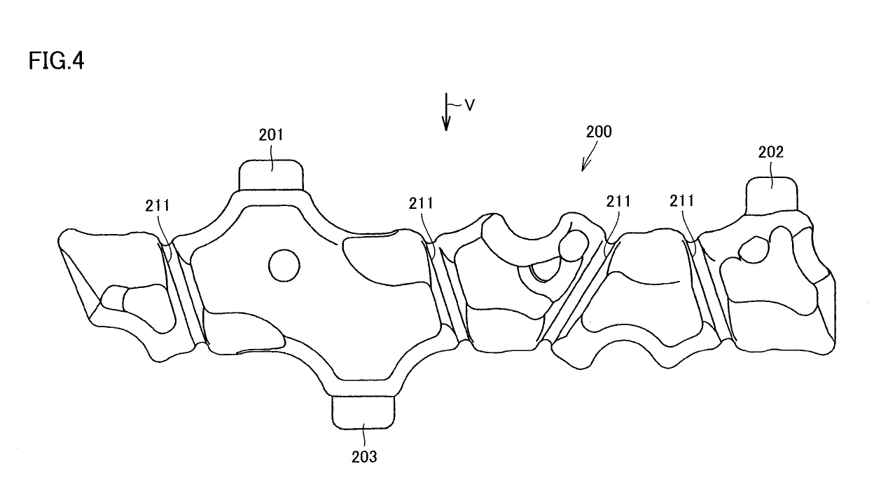

FIG. 4 is a plan of the sound insulation member viewed in a direction of an arrow IV in FIG. 3. Referring to FIG. 4, sound insulation member 200 is provided at its top surface with a plurality of concavities 211 extending in directions crossing the longitudinal direction for allowing easy deformation of sound insulation member 200. Projections 201, 202 and 203 are arranged in the portions other than concavities 211.

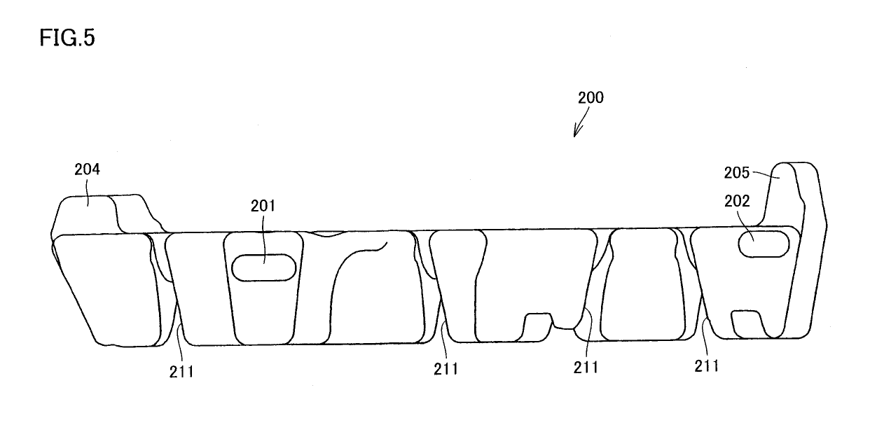

FIG. 5 is a side view of the sound insulation member viewed in a direction of an arrow V in FIG. 4. Referring to FIG. 5, projection 202 is arranged near leg 205, and projection 201 is arranged remote from leg 204. Each of projections 201 and 202 has a rounded outer periphery for easy engagement with the intake manifold.

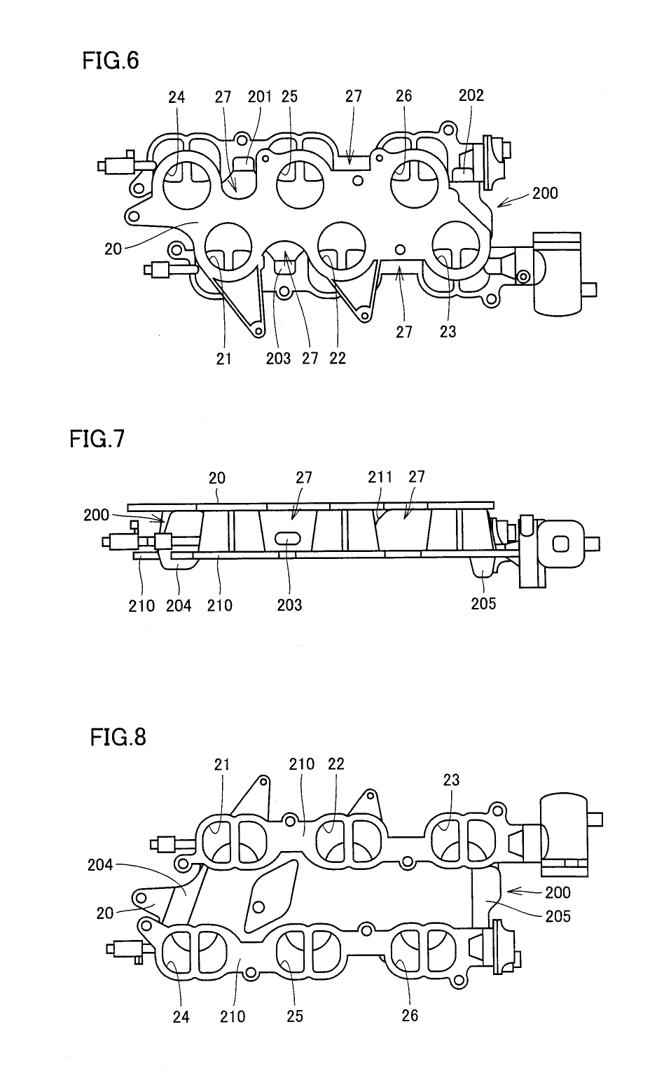

FIG. 6 is a plan of the intake manifold having the sound insulation member arranged therein. Referring to FIG. 6, intake manifold 20 has intake pipes 21, 22 and 23 for the right bank and intake pipes 24, 25 and 26 for the left bank which are coupled together. Projection 203 is engaged between right bank intake pipes 21 and 22. Projection 201 is engaged between left bank intake pipes 24 and 25. Projection 202 is engaged with left bank intake pipe 26.

FIG. 7 is a side view of the intake manifold having the sound insulation member arranged therein. Referring to FIG. 7, legs 204 and 205 protrude from the lower surface of intake manifold 20. Thereby, the space can be reliably and sealingly closed at the opposite ends of intake manifold 20. This can further increase the sound insulating performance. Legs 204 and 205 are not essential. Further, projections 201, 202 and 203 are not essential. Intake manifold 20 may be provided with a projection, which is engaged with sound insulation member 200.

FIG. 8 is a bottom view of the intake manifold having the sound insulation member arranged therein. Referring to FIG. 8, sound insulation member 200 has a worked or processed form conforming to right and left intake passages of intake manifold 20. Thereby, sound insulation member 200 can prevent leakage of the sound from the gap of intake manifold 20. Sound insulation member 200 having the form conforming intake manifold 20 can be produced, e.g., from a forming material using dies of the same form as intake manifold 20. Sound insulation member 200 may be made of, e.g., another foamed resin. Instead of the foamed resin, sound insulation member 200 may be made of a porous member.

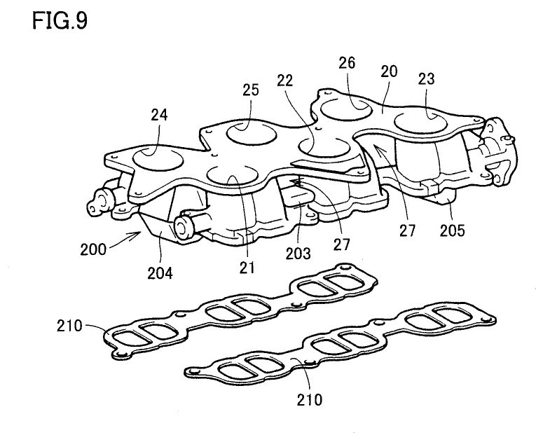

FIG. 9 is a perspective view of the intake manifold and gaskets. Referring to FIG. 9, intake manifold 20 has a form prepared by coupling a plurality of pipe members, and projection 203 is fitted into gaps 27 between them. Although this embodiment relates to a V-type 6-cylinder engine, this is not restrictive, and engines having more or fewer than 6 cylinders may employed the invention. A gasket 210 is a member for increasing gastightness between intake manifold 20 and the underlying cylinder head, and is made of, e.g., metal. In this embodiment, two intake valves are arranged per cylinder so that gasket 210 has two intake passages per cylinder. However, this is not restrictive, and a structure having one intake passage per cylinder may be employed.

Sound insulation structure 1 of the internal combustion engine according to the first embodiment includes V-type cylinder block 101 having right and left banks 1011 and 1012, right bank intake pipe 21 that is the first intake pipe and supplies the gas to right bank 1011, left bank intake pipe 24 that supplies the gas to left bank 1012 and intersects right bank intake pipe 21, in-cylinder injection injectors 11 and 12 that are the fuel injection devices and are arranged in surrounded space 29 surrounded by the right and left banks and the right and left intake pipes, and sound insulation member 200 located between in-cylinder injection injectors 11 and 12 and the intersection region where right and left bank intake pipes 21 and 24 intersect together, arranged in surrounded space 29, being in contact with right bank intake pipes 21, 22 and 23 and left bank intake pipes 24, 25 and 26, and extending in the direction of alignment of right bank intake pipes 21, 22 and 23 and left bank intake pipes 24, 25 and 26.

Projections 201, 202 and 203 of sound insulation member 200 are arranged between right bank intake pipes 21, 22 and 23 and left bank intake pipes 24, 25 and 26. Sound insulation member 200 has an integral form. The gap is formed between intersection region 28 and sound insulation member 200.

In-cylinder injection injectors 11 and 12 that are the high-pressure fuel injection valves generate operation sounds during the fuel injection. This operation sounds is propagated through an air to an interior of a vehicle, and therefore may affect silence of the vehicle. Members arranged around in-cylinder injection injectors 11 and 12 form a gap with respect to the intake pipe depending on the arrangement and configuration of intake manifold 20. Therefore, sound insulation member 200 is arranged for preventing the above operation sounds from being propagated through the gap thus formed to the outside of the vehicle room, and thereby the silence of the vehicle can be kept.

By arranging sound insulation member 200 between intersection region 28 and in-cylinder injection injectors 11 and 12, sound insulation member 200 can operate to cut off the sounds generated by in-cylinder injection injectors 11 and 12.

When sound insulation member 200 is arranged, a heat generating from cylinder head 120 may remain in surrounded space 29. Accordingly, the space formed between intersection region 28 and sound insulation member 200 can ensure an outer air passage to suppress rising of the temperature. Consequently, generation of a vapor inside in-cylinder injection injectors 11 and 12 can be suppressed. Although this embodiment relates to the structure having in-cylinder injection injectors 11 and 12 arranged in surrounded space 29, this is not restrictive, and port-injection injectors 13 and 14 may be arranged in surrounded space 29.

### Second Embodiment

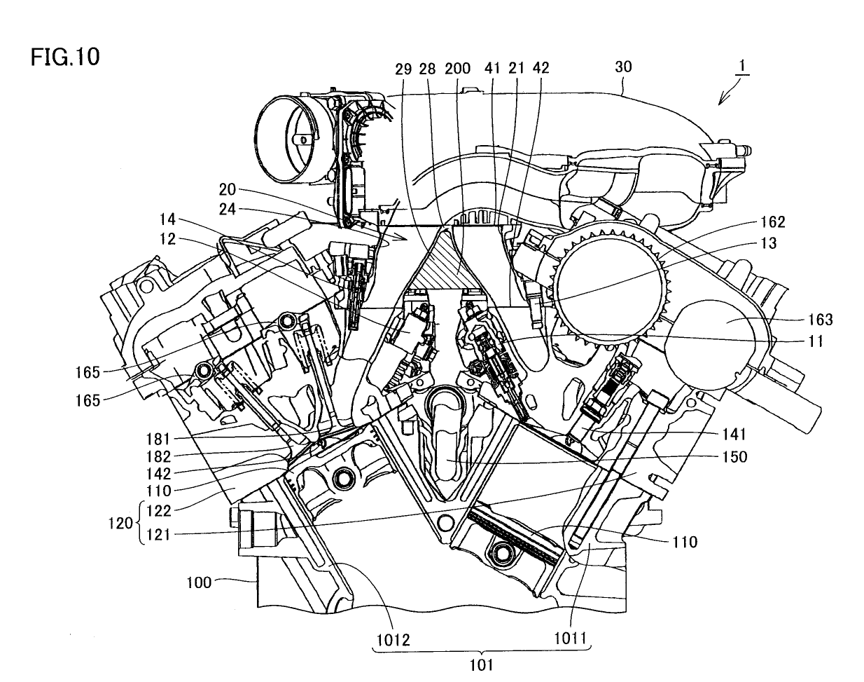

FIG. 10 is a cross section of a sound insulation structure of an internal combustion engine according to a second embodiment of the invention. Referring to FIG. 10, sound insulation structure 1 of the internal combustion engine according to the second embodiment of the invention differs from sound insulation structure 1 of the internal combustion engine according to the first embodiment in that sound insulation member 200 reaches intersection region 28. Since sound insulation member 200 reaches intersection region 28, sound insulation member 200 has a triangular form (i.e., a triangular prism form).

### Third Embodiment

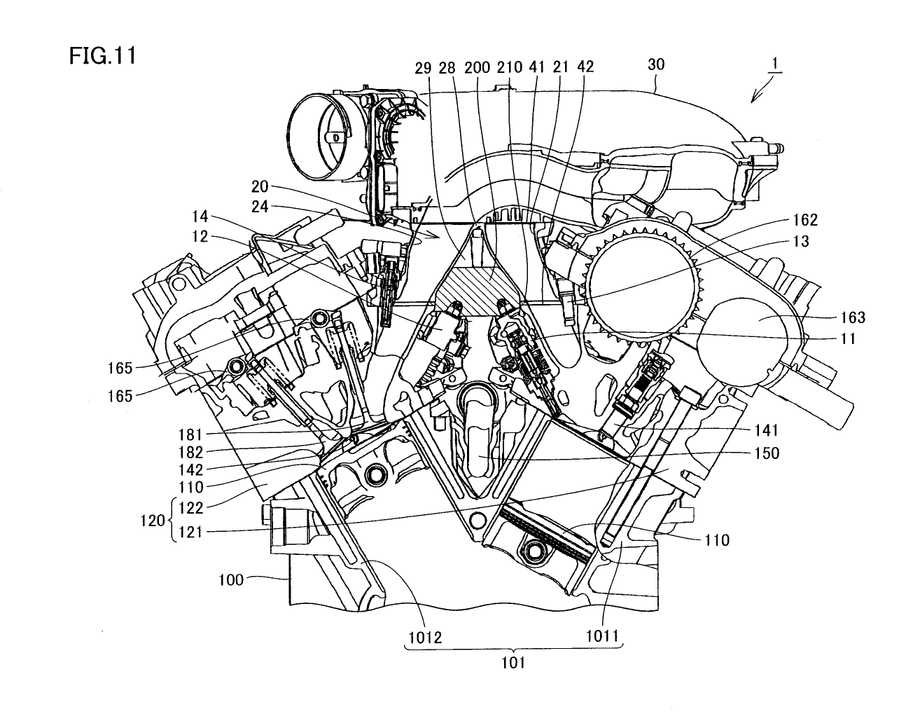

FIG. 11 is a cross section of a sound insulation structure of an internal combustion engine according to a third embodiment of the invention. Referring to FIG. 11, sound insulation member 200 according to the third embodiment of the invention is integral with gasket 210. Further, sound insulation member 200 is in direct contact with in-cylinder injection injectors 11 and 12. Sound insulation member 200 is not required to satisfy both the condition that it is integral with gasket 210 and the condition that it is in contact with in-cylinder injection injectors 11 and 12. For example, sound insulation member 200 that is integral with gasket 210 may not be in contact with in-cylinder injection injectors 11 and 12. Conversely, sound insulation member 200 that is in contact with in-cylinder injection injectors 11 and 12 may not be integral with gasket 210.

In sound insulation structure 1 of the internal combustion engine according to the third embodiment of the invention that has been described, since gasket 210 and sound insulation member 200 are integral with each other, heat conduction from cylinder head 120 to intake manifold 20 can be suppressed so that the rising of temperature of surrounded space 29 can be suppressed, and the vapor generation inside in-cylinder injection injectors 11 and 12 can be effectively suppressed. The urethane used as the sound insulation member achieves good sound insulation properties, light weight and flexibility, and allows easy working.

Although the present invention has been described and illustrated in detail, it is clearly understood that the same is by way of illustration and example only and is not to be taken by way of limitation, the scope of the present invention being interpreted by the terms of the appended claims.

### INDUSTRIAL APPLICABILITY

The invention can be used in the field of the internal combustion engine mounted on the vehicle.

1. A sound insulation structure of an internal combustion engine comprising:
a cylinder block having left and right banks;
a plurality of first intake pipes supplying a gas to said right bank;
a plurality of second intake pipes supplying the gas to said left bank and intersecting said first intake pipes;
a fuel injection device arranged in a surrounded space surrounded by said right and left banks and said first and second intake pipes; and
a sound insulation member arranged in said surrounded space between said fuel injection device and an intersection region containing intersecting portions of said first and second intake pipes, being in contact with both said first and second intake pipes and extending in a direction of alignment of said plurality of first and second intake pipes.

2. The sound insulation structure of the internal combustion engine according to claim 1, wherein
said sound insulation member is arranged between said plurality of first and second intake pipes.

3. The sound insulation structure of the internal combustion engine according to claim 1 or 2, wherein
said sound insulation member is arranged integrally.

4. The sound insulation structure of the internal combustion engine according to claim 1, wherein
a gap is formed between said intersection region and said sound insulation member.

5. The sound insulation structure of the internal combustion engine according to claim 1, further comprising:
a cylinder head arranged on said right and left banks, and
a gasket arranged between said cylinder head and said first and second intake pipes, wherein
said gasket is integral with said sound insulation member.

6. The sound insulation structure of the internal combustion engine according to claim 1, wherein
said sound insulation member is formed of urethane foam.

7. The sound insulation structure of the internal combustion engine according to claim 1, wherein
said sound insulation member is arranged in contact with said fuel injection device.

8. The sound insulation structure of the internal combustion engine according to claim 1, wherein
said sound insulation member is engaged between said plurality of first and second intake pipes.
